(19) United States
(12) Patent Application Publication
(10) Pub. No.: US 2008/0082397 A1
(43) Pub. Date: Apr. 3, 2008

(54) VENDOR SELECTION BASED ON AUCTION OF CLIENT MARKETING CATEGORIES

(75) Inventors: Jack Dennison, Westlake Village, CA (US); Sunil Mehrotra, Malibu, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Move, Inc.

(21) Appl. No.: 11/857,838

(22) Filed: Sep. 19, 2007

Related U.S. Application Data
(60) Provisional application No. 60/826,282, filed on Sep. 20, 2006.

(51) Int. Cl. G06Q 30/00; G06Q 10/00

(52) U.S. Cl. 705/10; 705/1; 705/14; 705/37

(57) ABSTRACT

Systems for targeting marketing to a user of a web site, providing advertisements to a consumer relating to various goods and/or services, and associating advertisements with a voucher are provided. According to one embodiment of the present invention, a system for targeting marketing to a user includes an interface viewable by a user via user selection, and a monitoring system associated with said interface and configured to gather information relating to the user's navigation on the interface. The system also includes a storage system comprising a list of categories associated with one or more goods and/or services, and a point assignment system associated with the monitoring system. The point assignment system is configured to assign points to the categories based on a user's navigation, and wherein the assigned points indicate a user's interest in one or more goods and/or services associated with the category.

### CROSS REFERENCE TO RELATED APPLICATION(S)

This application claims the benefit of U.S. Provisional Patent Application No. 60/826,282 filed Sep. 20, 2006, the content of which is incorporated herein in its entirety.

### BACKGROUND OF THE INVENTION

1. Field of the Invention

The present invention is related to systems and methods for marketing vendors' products and services to potential consumers and, in particular, to systems and methods for marketing via a vendor auction schema.

2. Description of Related Art

Vendors utilize various techniques to market products and services to potential consumers. A common way to present consumers with additional options is through advertising. For example, when a consumer enters a search request for goods or services, the consumer is presented not only with search results satisfying the request, but also an advertisement, where the advertisement solicits the consumer to purchase similar or competitive goods or services from the advertiser. Further, Internet web sites typically sell advertising space to vendors, where a user accessing a web site will also receive an embedded advertisement. In particular, banner ads or pop-up ads are frequently utilized on Internet for targeted advertising. Advertisers are willing to spend various amounts for a particular ad depending on the cost-per-thousand (CPM) or cost-per-click (CPC) value associated with the ad.

Vendors can target products or services to consumers based on particular criteria, such as types of web sites visited or products requested. Vendors can also target products or services based on the consumer's demographics, such as economic levels, geographic areas, or age ranges. Additionally, vendors can reduce marketing costs by utilizing targeted advertisements, as only those consumers that are most likely to respond to the ad are targeted. Vendors can also provide gifts, offers, and rewards at market value based on other similar offers from other vendors. By providing targeted advertising, vendors can also reduce the likelihood that consumers will receive unwanted advertisements, while also providing efficient and creative delivery of gifts, offers, and rewards to consumers that are of interest to the consumer. Vendors can enter into partnership agreements that allow vendors to provide referrals or alternatives for products or services that it may not have been otherwise able to provide.

Marketing not only provides a vehicle for vendors to sell products and services, but consumers may also benefit from vendor marketing. For example, marketing can provide the consumer with information and discounts meeting current consumer needs. Similarly, vendors can provide similar or related products or services through cross-marketing that the consumer may not have otherwise been aware of. In addition, vendors can provide the consumer with a centralized shopping experience that allows consumers the convenience of making several purchases or inquiries at one location, such as at a web site. Vendors may also provide special gifts, offers, or rewards to the consumer in response to visiting the vendor's web site or making particular purchases (e.g., buy one get one free). Moreover, vendors can provide consumers with competitive offers from various vendors for the same goods or services such that consumers will have different options to choose from.

One specific marketing technique is a gift book, which can include several offers, gifts, coupons, promotions, or rewards that vendors provide to consumers, such as a consumer that recently moved into a particular area. For example, the gift book could include coupons for specific restaurants that are located within the same area as the consumer's new home. The gift book might also contain other information about the consumer's new residential community as well as information about other products or services offered within or near the area. The coupons, promotions, and rewards included in the book regarding the featured vendors typically are arranged in advance through contractual relationships between the vendors and a service provider, such as a web site utilizing an interface for consumers to view and access various information and offers provided by the vendors. In this manner, not only does the service provider urge increased visits to its web sites, it also has created an ad revenue vehicle from third-party advertisers who wish to be featured on the web site.

Despite these improvements in providing targeted advertisements to potential consumers, there is a need for an improved marketing system that not only provides vendors with a vehicle for increasing consumers' interests but also the likelihood that the marketing will result in providing a product or service to a consumer. Conventional marketing schemes do not prevent the consumer from being overwhelmed with similar advertisements and do not necessarily result in the consumer receiving the most desirable gift, offer, or reward. Moreover, there is a need for targeted advertising that allows consumers to efficiently manage various gifts, offers, and/or rewards.

It would therefore be advantageous to provide systems and methods for providing targeted advertisements to consumers that increase consumers' interests and needs in goods and/or services. In addition, it would be advantageous to provide systems and methods for facilitating the management of various gifts, offers, and/or rewards.

### BRIEF SUMMARY OF THE INVENTION

Embodiments of the present invention address the above needs and achieve other advantages by providing systems and methods for providing targeted advertisements to consumers, allowing vendors to bid for placement of advertisements for consumers, and creating and facilitating the redemption of vouchers including one or more advertisements. For example, one embodiment of the present invention provides a system for targeting advertisements to consumers by monitoring information relating to a consumer's navigation on a web site. The system is capable of valuing various categories accessed by the consumer in order to provide a targeted advertisement based on an accumulated value. Moreover, aspects of the present invention facilitate vendor bidding for placement of advertisements based on the value of the advertisement to the consumer. As such, consumers may receive greater savings, while vendors may receive greater redemption of advertisements and interest in its goods and services. Furthermore, variations of the present invention provide a system for creating vouchers for consumers based on a consumer's interest in goods and/or services, as well as embodiments for monitoring a consumer's use of the voucher.

According to one embodiment of the present invention, a system for targeting marketing to a user of a web site is provided. The system includes an interface in the form of a web site configured to provide a series of web pages viewable by a user via user selection, and a monitoring system associated with the interface, wherein the monitoring system is configured to gather information relating to navigation of the user on the interface. In addition, the system includes a storage system comprising a list of categories associated with one or more goods and/or services, and a point assignment system associated with the monitoring system, wherein the point assignment system is configured to assign points to the categories based on user navigation, and wherein the points assigned indicate a user's interest in one or more goods and/or services associated with the category.

Aspects of the system include a storage system comprising a plurality of advertisements related to one or more goods and/or services, wherein each advertisement is associated with one or more categories of the one or more goods and/or services stored in the storage system. Moreover, the storage system may include categories that are hierarchal, such that the categories include one or more subcategories (e.g., one or more demographics). The interface may retrieve one or more categories from the storage system and display the categories to the user, thereby allowing the user to select categories for viewing. The storage system may store specific selections made by a user, and the interface may allow a user to select goods and/or services of interest and store them in the storage system along with an identification of the user.

As the user navigates the web site, the point assignment system may assign points to categories that relate to a user's selections, and the interface may customize the web site so as to display one or more advertisements to the user from categories having selected point values. The system could further include a search engine associated with the interface and the storage system, wherein the interface may allow the user to perform one or more searches for goods and/or services. At least some of the goods and/or services may have an associated geographic indicator, wherein the interface may display goods and/or services to the user having associated geographic indicators that correspond with that of the user. The system could also include an alert system that is associated with the interface and the storage system, wherein the user may select goods and/or services of interest with the interface and receive indications when offers are available for such goods and/or services.

An additional embodiment of the present invention provides a system for providing advertisements to a consumer relating to various goods and/or services. The system includes an interface in the form of a web site configured to provide a series of web pages viewable by at least one consumer via selection, and a storage system including a list of categories associated with one or more goods and/or services. The system also includes an entry system associated with the storage system, wherein the storage system is configured to receive and store advertisements (e.g., gifts, offers, and/or rewards) input by a vendor for one or more goods and/or services in the storage system and associate the advertisement with one or more categories. The system further includes an auction system associated with the interface, wherein the auction system is configured to allow vendors to place one or more bids for placement of advertisements in one or more of the categories, and wherein each bid is associated with a value of the advertisement to each consumer.

According to various aspects of the present invention, the system includes an advertisement monitoring system that is configured to allow each vendor to monitor statistics associated with an entered advertisement. In addition, each vendor may submit a bid having a desired value equal to the value of the advertisement to each consumer, wherein the auction system may compare a vendor's bid to other vendors' bids and select the bid having the greatest desired value. The vendor may submit an advertisement having an associated fair market value, wherein the auction system may compare a vendor's bid to other vendors' bids and select the bid having the greatest fair market value. The system could also include a bid valuation system for determining the fair market value of a bid entered by each vendor.

Embodiments of the present invention provide an additional system for providing advertisements to a consumer relating to various goods and/or services. As before, the system includes an interface, a storage system, and an entry system. The system also includes a monitoring system associated with the interface for gathering information relating to the consumer, and a categorization system associated with the monitoring system for generating one or more categories based on the information relating to the consumer. Furthermore, the system includes an auction system associated with said interface for allowing vendors to place bids for placement of advertisements in one or more of the generated categories.

Variations of the system include an auction system configured to receive bids in the form of a traffic-based bid, wherein each vendor is capable of bidding a desired value for a predetermined number of selections by a consumer. The auction system may receive bids in the form of a time-based bid, wherein each vendor is capable of bidding a desired value to be an exclusive provider of one or more goods and/or services for a category. Moreover, the interface may list more than one advertisement for one or more goods and/or services in a hierarchal list, and each vendor may bid a desired value to have the vendor's advertisement appear higher in the hierarchal list. The monitoring system could gather information relating to navigation of the at least one consumer on the interface, and/or gather information relating to the demographics of the consumer on the interface.

An additional embodiment of the present invention provides a system for providing one or more advertisements to a user relating to various goods and/or services. The system includes an interface in the form of a web site configured to provide a series of web pages viewable by a user via selection, and a monitoring system associated with said interface for gathering information relating to navigation of the user on the interface and monitoring a user's interest in one or more categories. The system also includes a storage system comprising a list of categories associated with one or more goods and/or services, wherein each category includes one or more advertisements for goods and/or services. Additionally, the system includes a voucher generation system associated with the interface and the storage system, wherein the voucher generation system is configured to generate a voucher comprising one or more advertisements. The voucher generation system is also configured to include one or more advertisements in the voucher from a category indicated by the monitoring system as an interest of the user.

Aspects of the system include a voucher generation system having one or more advertisements in the voucher selected by the user. The voucher generation system may further include one or more advertisements in the voucher available in the geographic location of the user, associated with a demographic of the user, and/or relating to a current sales campaign. The voucher could be a booklet distributed to a user, a card distributed to a user, an email distributed to a user, or a downloadable file storable on a personal digital assistant. In addition, the system could further include a point assignment system associated with the monitoring system for assigning points to each of the categories based on user navigation, wherein the assigned points indicate a user's interest in one or more goods and/or services associated with each category.

Another embodiment of the present invention provides a system for associating advertisements with a voucher. The system includes an interface in the form of a web site configured to provide a series of web pages viewable by a user via selection, and a storage system including a list of categories associated with one or more goods and/or services, wherein each category comprises one or more advertisements for goods and/or services. The system also includes a voucher generation system associated with the interface and the storage system, wherein the voucher generation system generates a voucher for a user and creates a data log in the storage system that associates a unique identification of the voucher with at least one advertisement. The system further includes a redemption system associated with the storage system for monitoring use of the voucher by a user.

Variations of the system provide a voucher having an associated memory configured to store more than one advertisement thereon. The redemption system may access the storage system and download additional advertisements to the memory associated with the voucher when a user redeems a first advertisement from the voucher. Moreover, the redemption system may access the data log stored in the storage system and indicate that the advertisement has been redeemed when the user redeems an advertisement from the voucher. The interface may allow a user to access the data log associated with the user.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a pictorial diagram illustrating a client-server network, according to one embodiment of the present invention;

FIG. 2 is a block diagram illustrating a system for targeting advertisements to a user, according to an additional embodiment of the present invention;

FIG. 3 is a block diagram illustrating a system for providing advertisements to a user relating to various goods and/or services according to another embodiment of the present invention;

FIG. 4 is a block diagram illustrating a system for providing advertisements to a user relating to various goods and/or services according to one embodiment of the present invention;

FIG. 5 is a block diagram illustrating a system for assimilating and delivering one or more advertisements to a user according to another embodiment of the present invention;

FIG. 6 is block diagram illustrating a system for associating advertisements with a voucher according to an additional embodiment of the present invention;

FIGS. 7 and 8 are web pages depicting various gifts and offers according to another embodiment of the present invention;

FIG. 9 is a web page illustrating search results for a particular category and geographic area according to one embodiment of the present invention;

FIG. 10 is a web page showing a user's gifts and offers according to another embodiment of the present invention;

FIG. 11 is a web page illustrating various categories that may be selected for receiving alerts regarding advertisements according to an additional embodiment of the present invention;

FIG. 12 is a web page illustrating a new advertisement resulting from setting up an alert according to another embodiment of the present invention;

FIG. 13 is a web page depicting a gift book created for a third party according to one embodiment of the present invention; and

FIG. 14 is a web page showing a partner's web site according to an additional embodiment of the present invention.

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

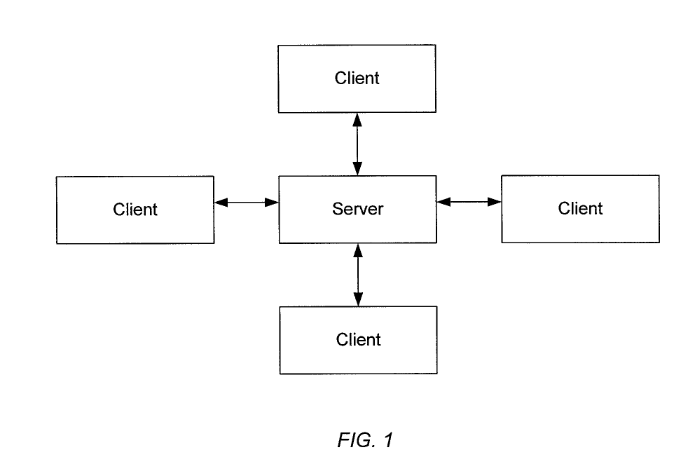

Referring now to the drawings and, in particular to FIG. 1, there is shown a system for communicating through a network. The system generally includes a client-server system interconnected through a network. The system is applicable to any number industries, such as the real estate, travel, or home improvement industries. Although embodiments of the invention are explained below in connection with real estate location services, they are not limited to such products and services. Therefore, the general approach could be extensible to any number of goods and/or services that can be marketed through the system shown in FIG. 1.

As referred to herein, the terms “client” and “server” are generally used to refer to a computer's role as a requester of data (i.e., the client) and a provider of data (i.e., the server). The client and server may communicate via a communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a cable television network, or an Internet Protocol (IP) network such as the Internet, an intranet, an extranet, or any other suitable network. As also used herein, the term “client device” corresponds to any suitable computing device, typically a computer, a personal data assistant, mobile phone, or the like, capable of communicating with a server. Likewise, the server is generally comprised of a computing device having at least one or more processors and associated memory device(s) as known to those skilled in the art. The client device and server may comprise any number of conventional components but typically includes a graphical user interface, bus, central processing unit (CPU), read-only memory (ROM), random access memory (RAM), storage device, input/output controller, network interface, and programs having software, as all known to those skilled in the art. Any number of client devices and servers may be included in the system and in communication with one another.

In a web environment, web browsers reside in clients, and specially formatted “web documents” reside on and/or are constructed by web servers. In operation, a browser opens a connection to a server and initiates a request for a document. Typical examples of “browsers” include Netscape Navigator by Netscape Corporation, Internet Explorer® by Microsoft Corporation, and Opera® by Opera Software A/S. The server delivers the requested document, typically in the form dictated by a standard such as the “HyperText Markup Language” (HTML) format. After the document is delivered, the connection is closed. The browser displays the document or performs a function designated by the document. For example, the browser may render the document at the client device as a web page on a web site, such as via a graphical user interface associated with the client device.

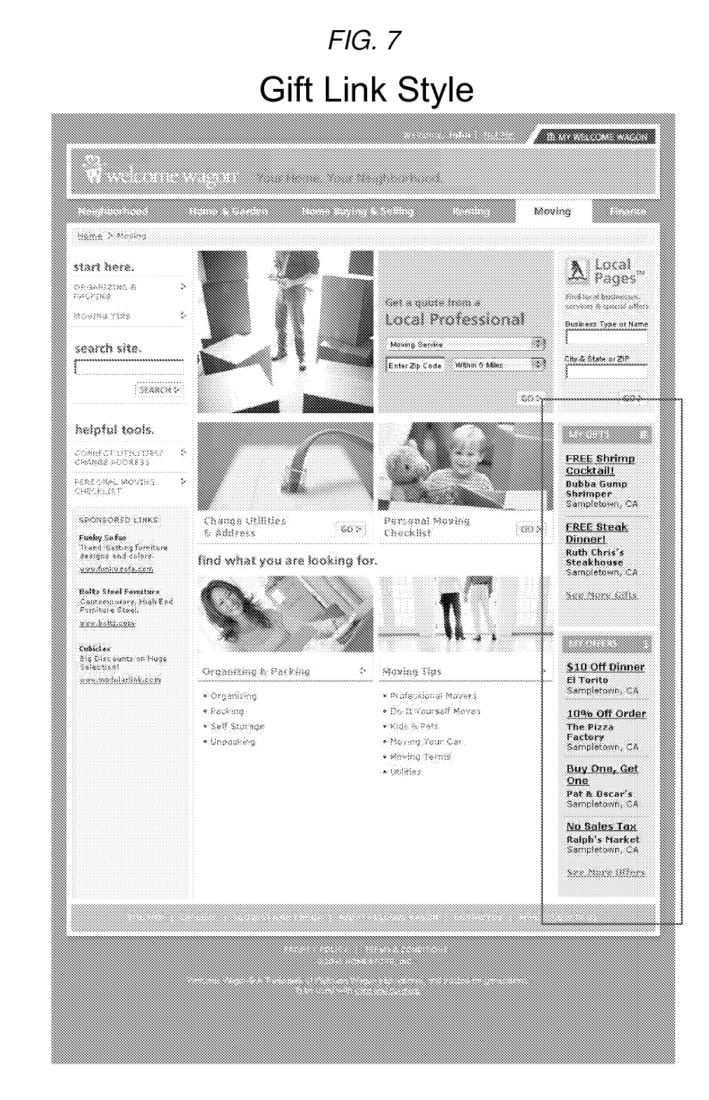

The documents delivered in accordance with embodiments of the present invention include advertisements, as described below. As used herein the terms “advertisement” or “ad” are not meant to be limiting. The terms advertisement or ad could be a promotional communication between a seller offering goods or services to a prospective purchaser of such goods or services. In addition, the advertisement or ad could contain any type or amount of data that is capable of being communicated for the purpose of generating interest in the sale of goods or services. For instance, each advertisement or ad may include one or more “gifts, “offers,” and/or “rewards.” A gift corresponds to particular goods or services that only require redemption by the consumer; an offer corresponds to goods or services that are available to consumers and require some form of consumer participation, input, and/or obligation; and a reward corresponds to goods or services available to a consumer following the satisfaction of predetermined criteria specified by the vendor. The advertisement or ad could be communicated in various forms, such as with image or textual data. Thus, the advertisement or ad could include, for example, graphical information about a product or service, a coupon, a downloadable file, or any other commercial information (and may also include text, animation, video, audio, and/or executable information) displayed at the client device. For example, FIGS. 7-10 illustrate different techniques for displaying offers and gifts to consumers.

Various amounts of information can be collected regarding consumers in order to provide targeted advertisements to a specific consumer. For example, the historical internet usage of the consumer may be monitored using techniques known to those of ordinary skill in the art to collect data relating to a consumer's internet usage and web site traffic. In addition, questionnaires may be used to directly solicit feedback from the consumer. Thus, in-person or telephonic surveys may be employed and collected by consumer service personnel, marketers, and the like. Similarly, online surveys may be utilized, such as traditional surveys where a user is presented with a series of questions designed to collect specific information about a user, or topical surveys, where a user is presented with a plurality of topics and categories and can select various topics of interest as the user navigates the various categories.

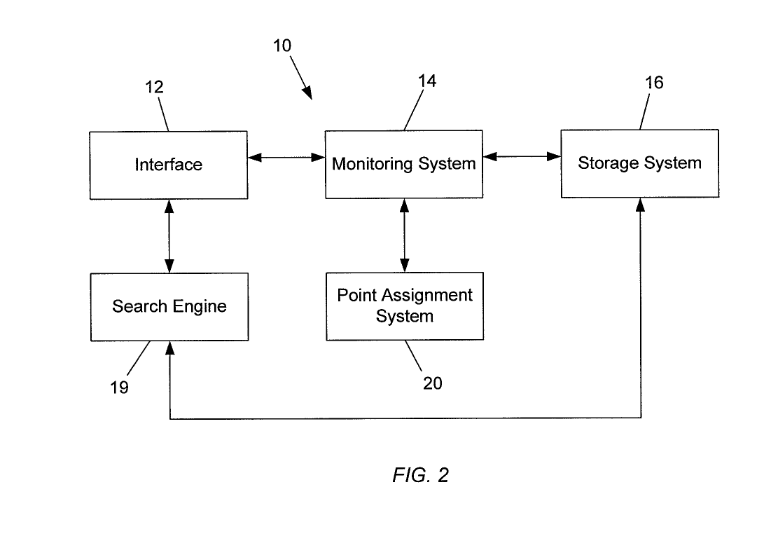

Furthermore, advertisements may be targeted to potential consumers based on a user's web site interaction. For instance, FIG. 2 demonstrates a system 10 for targeted marketing by assigning points to different categories for goods and services based on a user's selections such that users accumulating a particular value will be provided a targeted advertisement. The system 10 generally includes an interface 12 communicating with a monitoring system 14 and storage system 16. The system 10 also includes a point assignment system 18. The interface 12 could be a web site providing a series of web pages that are selectable and viewable by a user, or other interface facilitating user interaction. The monitoring system 14 is capable of gathering information relating to the user's navigation on the interface, such as a user's interest in one or more categories containing goods and/or services. Moreover, the storage system 16 is typically a database or memory capable of storing various information, including categories associated with one or more goods and/or services that are viewable and selectable by the user. As the user navigates on the web pages via the interface 12 and selects various categories, the point assignment system 18 assigns points to each category in order to indicate a user's interest in goods and/or services within a respective category. The system 10 may also include a search engine 19 for allowing a consumer to perform searches for goods and/or services.

For example, a user could select a general category, such as home accessories, which would be assigned a number value. The user could then select a subcategory of appliances, which would be assigned an additional number value. The user could further select kitchens and be assigned another value, and then select ovens and be assigned an additional value. The points accumulated from selecting each category would result in the user receiving an advertisement corresponding to the accumulated value. As such, the categories are quantifiable based on a user's interest in one or more categories.

Information may also be collected in response to various consumer experiences. For instance, the system may collect information in response to a consumer's interaction with a web site semi-passively or actively. In particular, the system may provide targeted marketing based on cookies generated from a consumer's previous browsing, or the system may initially present standard advertising based on advertisement contracts with vendors. Similarly, the system may collect data based on a user's interactions with a web site. For instance, points can be assigned to various topics and items that the user can click through while on the web site, as described above, and the points can be associated with the user similar to a cookie placed on the user's client device. In addition, advertisements on the web site can become more focused as a user exhibits an affinity for certain categories and items. Consumers may also perform searches on the web site that are evaluated to determine the category and specific advertisements to display to the consumer (e.g., searches for an item or based on a particular geographic indicator, such as zip code, city, or indicator resulting from consumer interaction on a web site or using other techniques). Alternatively, a consumer can view a list of categories of products and services and select various items of interest.

In addition, information could be collected regarding the user's selection of specific goods and/or services that the user would like to receive information about. The user could also specifically designate gifts, offers, and/or rewards. For example, a user presented with gifts, offers, and/or rewards could select desired gifts, offers, and/or rewards and place them in a gift basket, which could be stored in a database with a unique identification associated with the user.

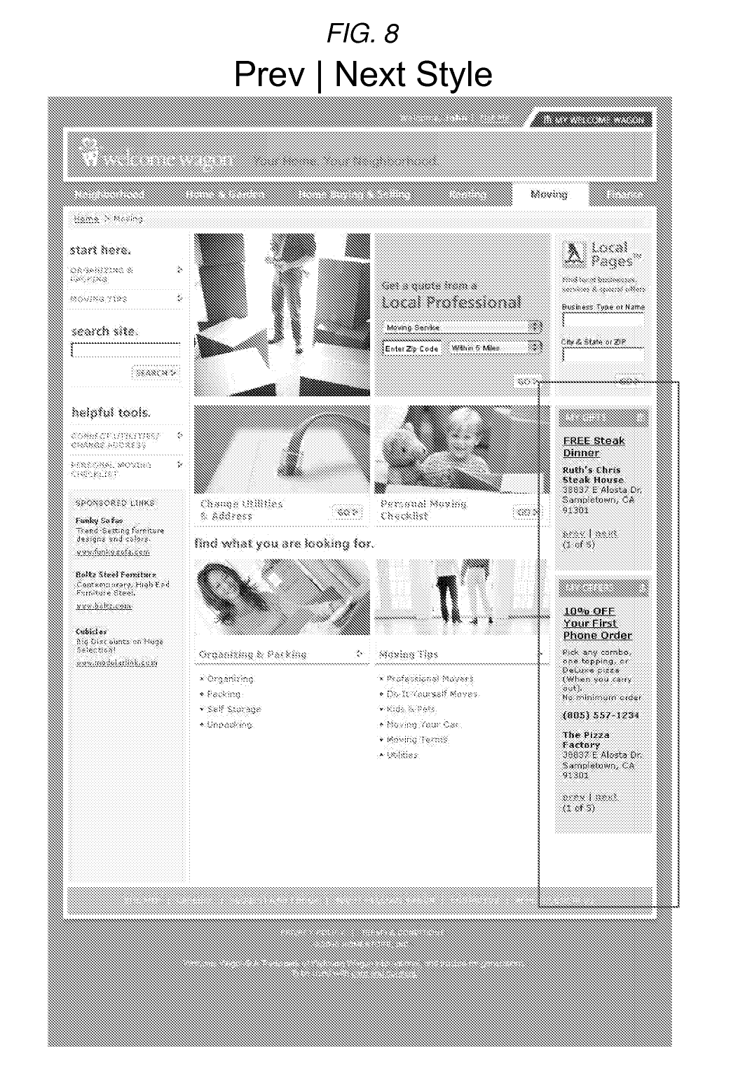

Embodiments of the present invention facilitate the generation and management of designated gifts, offers, and/or rewards that may be stored for each consumer, such as shown in FIGS. 7-10. FIGS. 7 and 8 show “My Gifts” and “My Offers,” which correspond to gifts and offers that have been selected by the consumer or provided by a vendor. FIGS. 7-10 illustrate that advertisements may be displayed in various manners on a web page rendered on the client device. In particular, FIG. 7 shows the advertisements displayed along a right-hand margin of the web page, where the advertisements have been separated into “My Gifts” and “My Offers.” However, the display should not be limited to that shown, as various formats or techniques may be employed to display the ads. In such a manner, the consumer is able to easily view, edit, and access each gift, offer, and/or reward associated with a consumer in a designated gift basket.

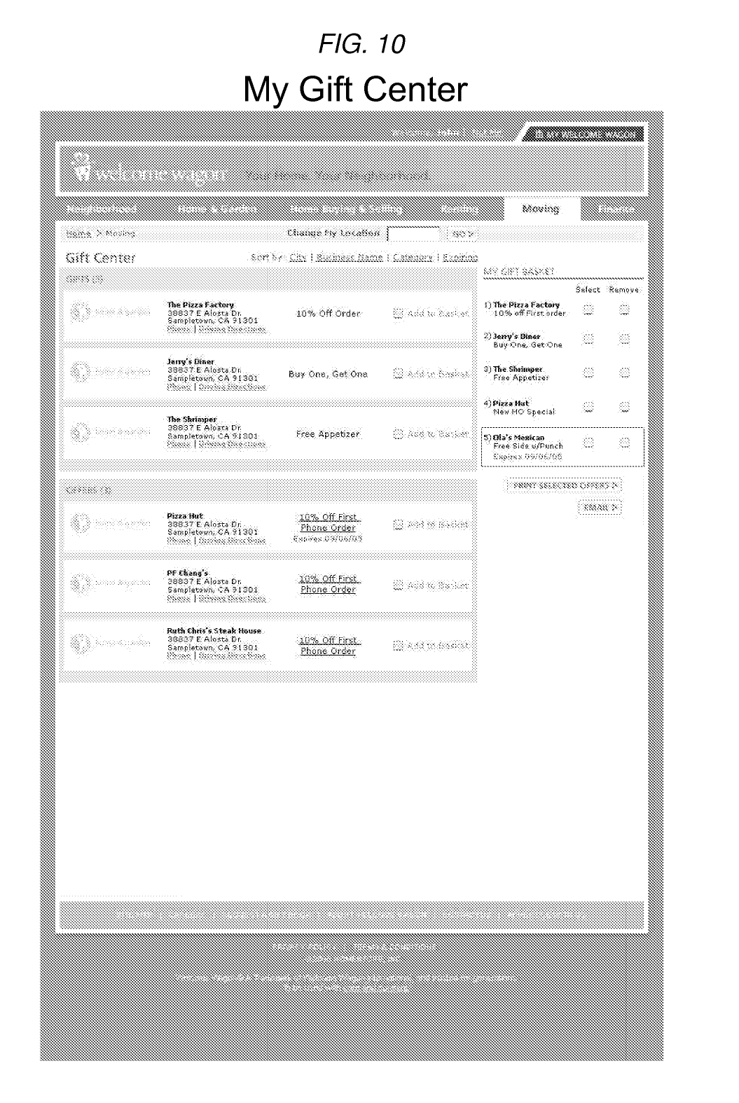

As shown in FIG. 10, a web site typically provides a gift basket center that allows a user to select various gifts, offers, and/or rewards presented at the client device in order to be placed in the consumer's designated gift basket. The web site displays various gifts, offers, and/or rewards to users based on information for targeting potential consumers, as described above. For example, techniques that could be used include consumer cookies indicating a user's web site interaction, consumer click throughs on the web site indicating a user's interest, searches performed on the web site by consumer, or specific gifts, offers, and/or rewards selected by the consumer. The system facilitates the selection of various items to place in a gift basket such that the selected gifts, offers, and/or rewards are made available to the consumer, where redemption of specific items within the consumer's gift basket will be described in greater detail below.

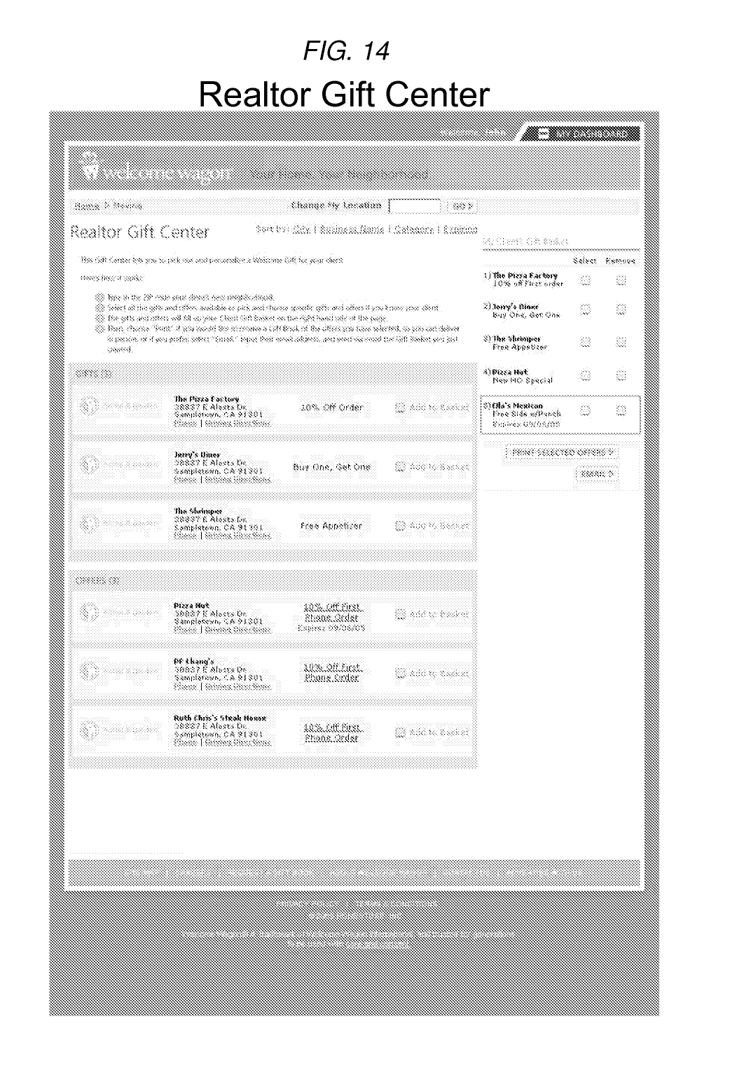

Additional aspects of the system include the generation of gift baskets for third parties. For instance, a gift basket containing various gifts, offers, and/or rewards could be created for a client such as a realtor for a client, as shown in FIG. 14. FIG. 14 demonstrates that a realtor could enter a geographic area of the realtor's client (e.g., zip code) and select gifts, offers, and/or rewards for inclusion in a gift basket. In addition, a third party can create a gift basket and have selected items from the gift basket sent to a consumer, or the third party can send a link to the consumer and allow the consumer to create his or her own gift basket.

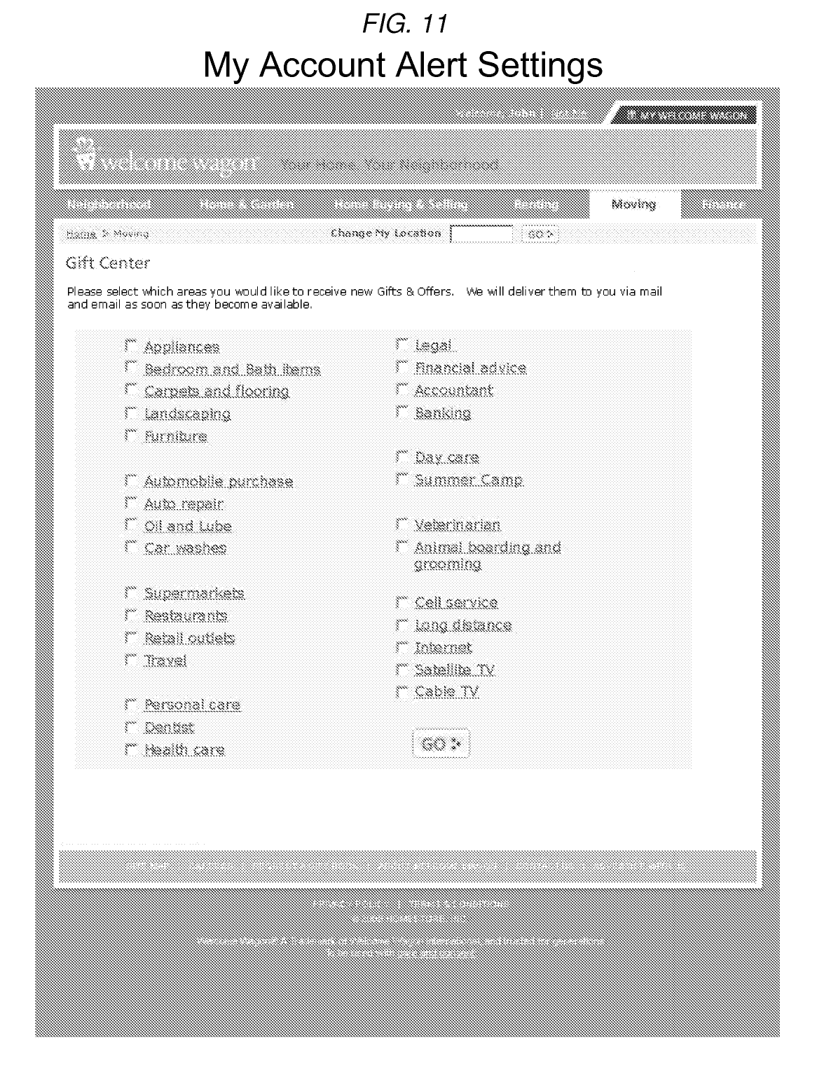

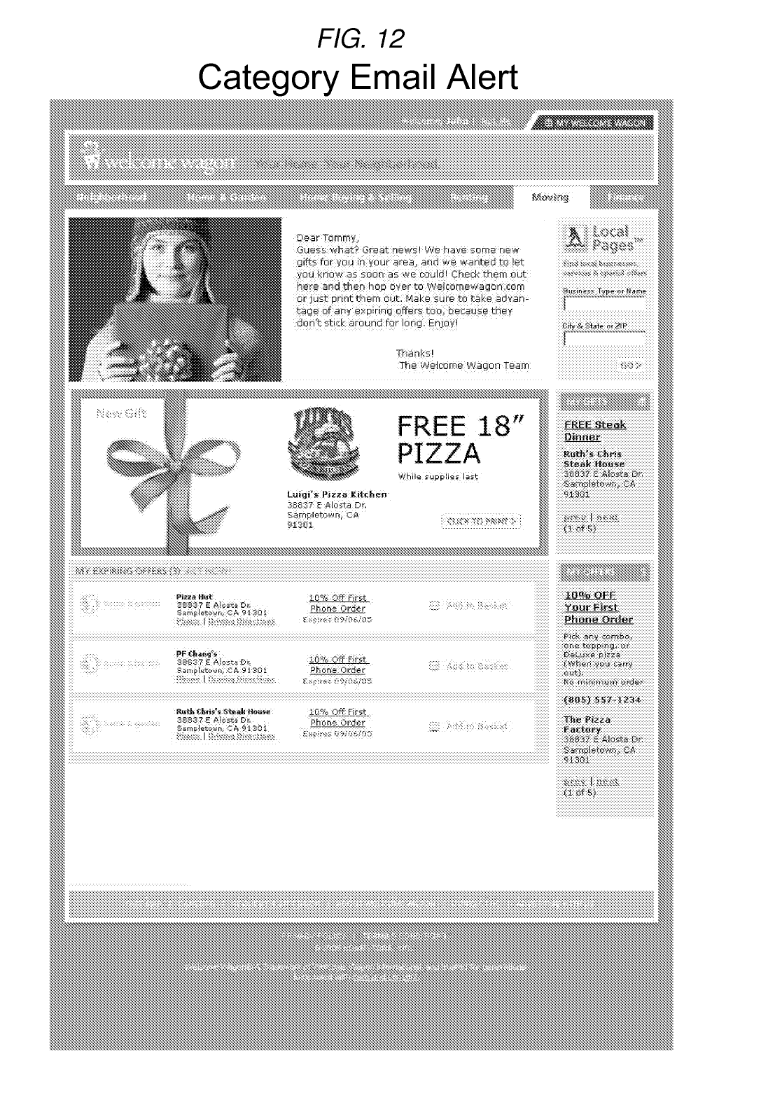

Furthermore, consumers could also receive alerts regarding future gifts, offers, and/or rewards relating to a specific category or item that the consumer has currently or previously expressed an interest in. For instance, a consumer could receive alerts in response to new gifts, offers, and/or awards based on desired categories and/or items of interest. For example, FIGS. 11 and 12 demonstrate that a consumer may select various categories that a consumer is interested in receiving alerts regarding gifts, offers, and/or rewards. FIG. 12 illustrates that a new gift (i.e., Free 18″ Pizza) has been provided to the consumer in response to a request for a particular category of goods and/or services (e.g., restaurants). FIG. 12 also depicts offers that are expiring soon in order to provide a reminder to consumers to redeem a particular gift, offer, and/or reward that has been selected or provided to the consumer. Additionally, the system may provide alerts either via the gift basket, such as by directly depositing a gift, offer, and/or reward in the gift basket, or using other notification techniques, such as via a cell phone, PDA, or email when gifts, offers, and/or rewards are offered for the selected categories and/or items.

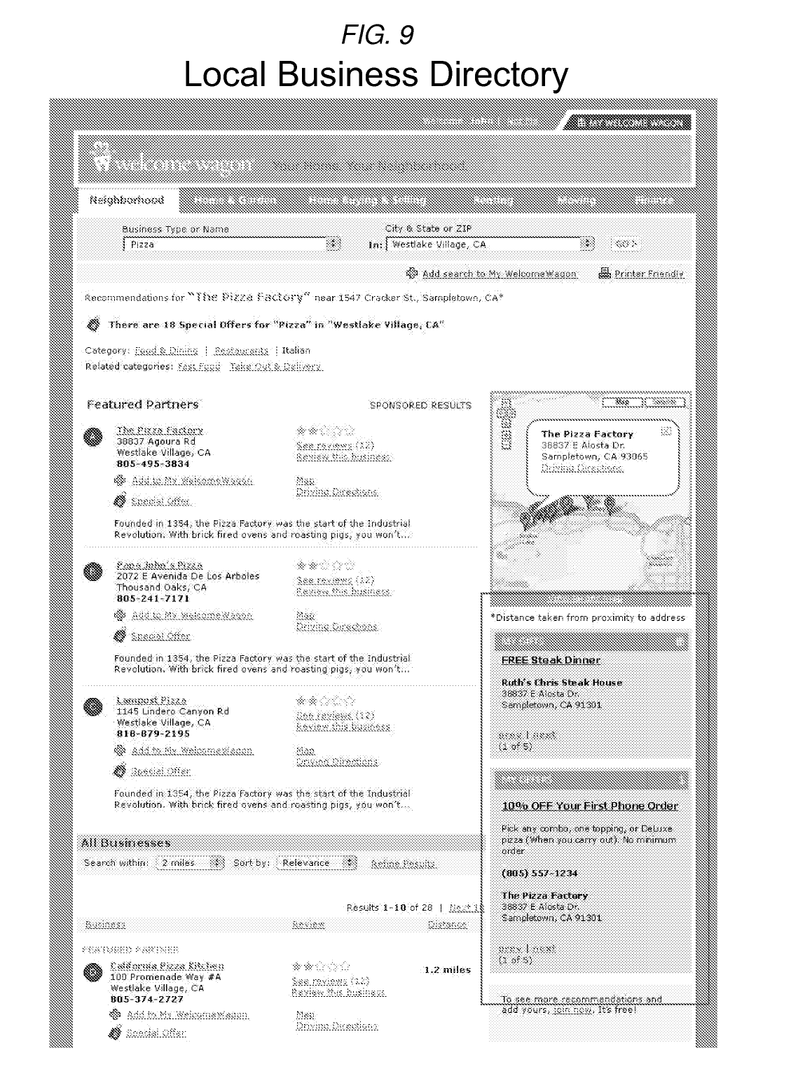

Moreover, FIG. 9 demonstrates that a user can perform a search for gifts, offers, and/or rewards, and in this particular example, the user has performed a search for “pizza.” The search results can be displayed in various forms and, as also shown in FIG. 9, the results may be displayed in a list form, as well as on a geographic map, where the geographic map displays geographic locations of vendors for redeeming items. The search results could also contain various information associated with each vendor, such as address, phone number, ratings, and a link to each vendor's web site. Furthermore, the search results may include featured partners that are given priority placement on the web page (i.e., first in a list of search results), as will be explained in further detail below.

Each of the advertisements (e.g., gifts, offers, and/or rewards) may be categorized in various manners. According to one embodiment, the advertisements are categorized by a particular type of goods and/or service (e.g., restaurants), and the categories are stratified from a more general topic to one or more specific topics (e.g. home furnishings, kitchen, kitchen appliances, ovens). In addition, the advertisements may be categorized by a particular geographic location, such as a city or zip code, as well as a consumer's demographics, such as gender, race, ethnicity, and economic status. Categorization may also be based on the perceived needs of a consumer. For instance, information may be gathered based on a consumer's interaction with a web site or other techniques (e.g., surveys) to determine the consumer's perceived interests in a particular good or service. A new home buyer, for example, may be interested in categories relating to new homes (e.g., home improvement goods and/or services).

Each category is populated with one or more advertisements. Categories may be populated with advertisements using various techniques, such as a consumer's web site interaction, questionnaires, historical web site usage, click throughs, and/or designated alerts, as described above. Thus, various forms of interactive information may inform vendors of the types of gifts, offers, and/or rewards consumers are interested in receiving. This data may used to market to vendors, such as by providing information indicating that consumers commonly request goods or services associated with the vendor. Conversely, data may also be used directly by vendors as an aid to determine the value of an advertisement in a category.

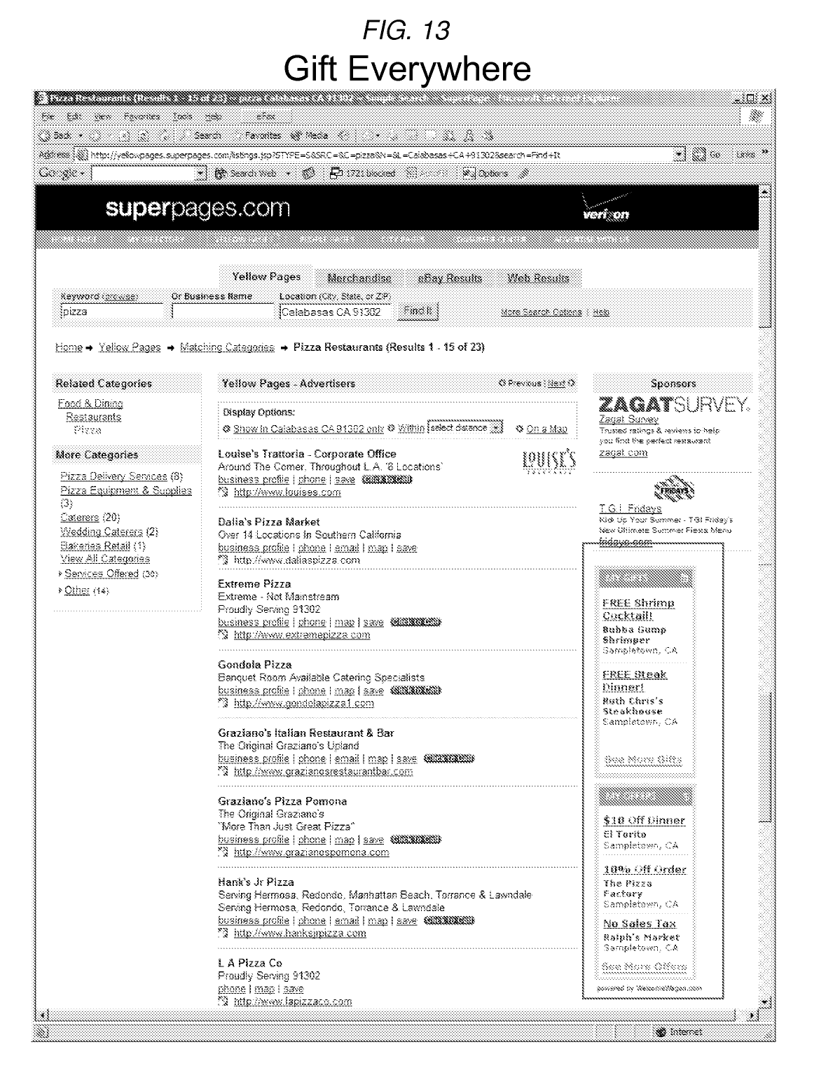

Various marketing strategies could also be utilized to increase the exposure of a vendor's advertisements, such as placing a link on a partner's web site to a web site including one or more advertisements. For example, FIG. 13 depicts a partner's web site that provides links to vendors providing one or more gifts, offers, and/or rewards in response to a consumer's search in a specific category (i.e., pizza). Consumers are also able to view their gift basket on partners' web sites, as also shown in FIG. 13. Vendors could pay partners for any traffic that is directed to web sites including the advertisements. As such, the partner's consumers are provided access to the vendor's advertisements, and the partner's vendors may also be given increased exposure, such as where the partner's vendors also provide advertisements on the linked web site. The traffic directed from a partner's web site to vendors may be monitored to ensure that the relationship is generating a desired amount of redirected traffic.

Embodiments of the present invention also provide a vendor interface for inputting advertisements into the system. The vendor interface could be a web site that provides one or more web pages that enable vendors to input advertisements. For example, the vendor interface could be a portal that facilitates that entry of advertisements. The vendor could enter advertisements, key words, geographic and demographic information, as well as information regarding a particular vendor. The portal may be configured to categorize the advertisement, apply rules to the advertisement, as well as delineate whether the advertisement is a gift, offer, or reward. The gift, offer, or reward could be then delivered to an interface viewable by a consumer whereby the vendor can monitor the gift, offer, or reward and monitor statistics associated therewith. For instance, the vendor could monitor the frequency of selection of a particular gift, offer, or reward, or particular characteristics of the consumer that selected the gift, offer, or reward.

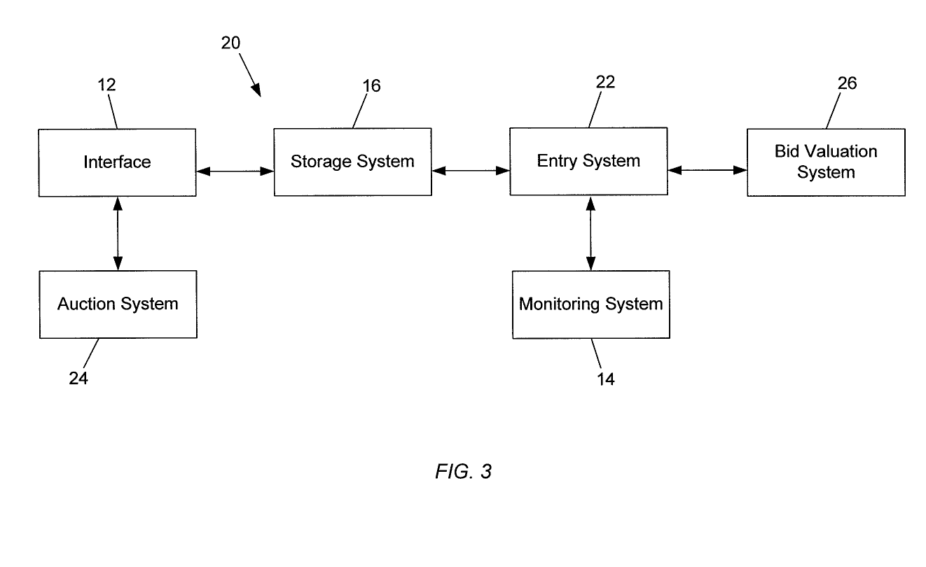

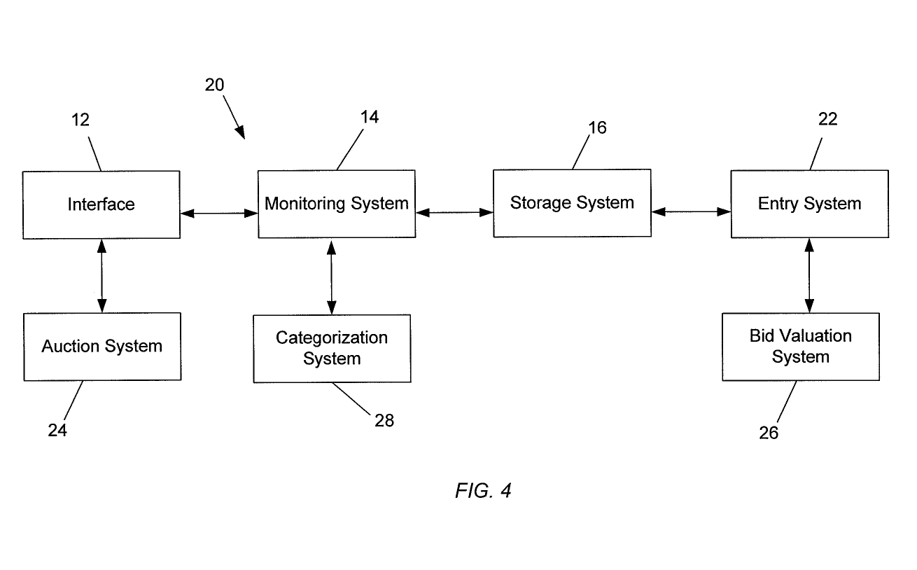

Additional aspects of the present invention provide an auction system that enables vendors to submit bids for placement of advertisements in one more categories, as shown in FIGS. 3 and 4. In particular, FIG. 3 illustrates a system 20 including an interface 12, a storage system 14, and an entry system 22 whereby vendors may input advertisements for goods and/or services in the storage system and associate each advertisement with a respective category. The system 20 also includes an auction system 24 that is employed to allow vendors to place bids for inclusion within one or more categories. The system 20 may further include a monitoring system 14 for monitoring statistics associated with the advertisement, such as the frequency of selection or redemption by consumers. Additionally, the system 20 could include a bid valuation system 26 for determining the fair market value of the bid, as described in further detail below. FIG. 4 illustrates an additional aspect of the auction system 20 wherein the system further includes a categorization system 28 that is capable of generating one or more categories based on information relating to the consumer and/or the consumer's interaction on the web site. As described above, the advertisements may be categorized by a particular geographic location, a consumer's demographics, and/or the perceived needs of a consumer.

Each bid typically has an associated value of the advertisement to the consumer. In this regard, the bids may be value-based, such that the vendor's proposed offer, gift, or reward defines the value of the offer, gift, or reward to the consumer or the fair market value of the bid to the consumer. For example, if Lowe's offers a $50 gift certificate and Home Depot offers a $25 gift certificate, Lowe's would be given a higher value to the consumer. The particular value of a bid may be not clearly differentiated such that algorithms could be utilized for valuating the fair market value of the bids. For instance, Vendor₁ offers a 10% discount with a purchase of $5 or more, and Vendor₂ offers a 15% discount with a purchase of $10 or more, such that the system could select the greatest discount or some combination of minimum purchase and percentage discount.

The bids could also be in the form of a value to each vendor. Namely, vendors may provide bids having a value equal to what the vendor is willing to pay for placing the advertisement in one or more categories that are accessible by consumers. For example, the bids may be fee-based such that vendors submit a dollar amount to be paid for having an advertisement in a category or to be ranked higher in a particular category. Vendors could also place bids for different geographic areas and different demographics within the categories (e.g., zip code or geographic radius). For example, if a vendor sells kitchen appliances in a specific geographic area(s), the vendor can bid to have advertisements displayed in one or more kitchen appliance categories in a particular geographic area(s) and may display different appliance items to different consumers having a particular demographic. The vendor could utilize a portal, as described above, to place bids for viewing by consumers.

The bids may take various forms, such as a time-based or traffic-based bid. Time-based bids are configured to be offered for a predetermined period of time (e.g., one week) whereby the advertisement is accessible by consumers. Traffic-based bids allow vendors to submit bids for a predetermined number of selections (e.g., 100 selections) by consumers for a particular advertisement. The bids may be exclusive, such that a vendor bids to be an exclusive advertiser for a specific category, demographic, and/or geographic area. In addition, the bids could also be hierarchal such that higher bids are given priority over lower bids for placement on a particular web page. Referral bidding may also be employed, where vendors place bids for actual consumers (e.g., click based on a web page) or for a number of hits from consumers, which may result in a number of actual consumers. For instance, a vendor paying for 100 hits on a particular advertisement may expect 10 consumers that actually redeem the gift, offer, or reward.

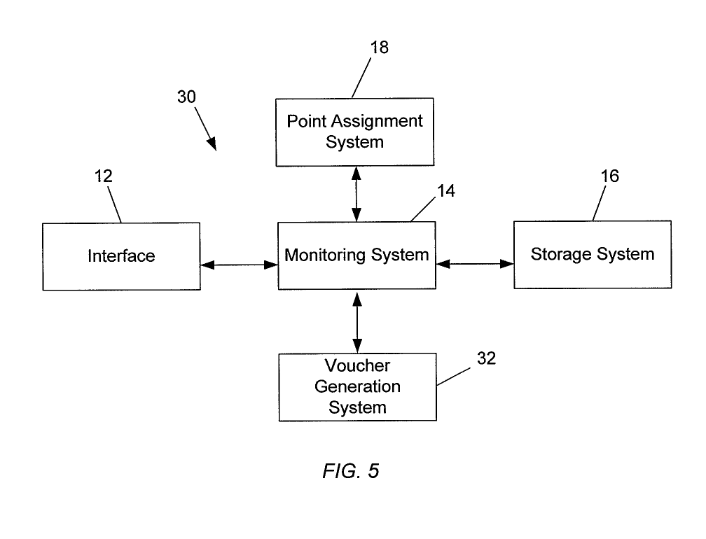

Additional embodiments of the present invention provide vouchers that include one or more advertisements and that are delivered to the consumer for redemption. FIG. 5 depicts a system 30 that includes a voucher generation system 32 for generating a voucher including one or more advertisements based on a consumer's interest in a particular category. The voucher could correspond to items contained within the consumer's gift basket, as shown in FIGS. 7-10.

Various techniques could be used to communicate vouchers containing one or more advertisements to the consumer. For example, redeemable gifts, offers, and/or rewards may be sent to the consumer via email to a personal digital assistant (PDA) for downloading. The consumer may also be provided a specific code for use with Internet purchases or printed for use in store locations.

According to one aspect of the present invention, the voucher could also be sent to the consumer (e.g., via the post office) and may take the form of a coupon, booklet, gift card, or the like. The gift card may include one or more advertisements corresponding to advertisements contained in a consumer's gift basket. Thus, items from the consumer's gift basket are downloaded to a host computer. The items are then placed on a gift card, such as in a magnetic stripe or smart card chip. The card is then mailed to the user. The consumer's client device may include software that allows users to personalize print on the face of the card. Furthermore, a blank gift card may be sent in a gift packet to a consumer. For instance, the consumer may access a web site and fill a gift basket including one or more advertisements.

FIG. 5 depicts a further aspect of the present invention, wherein a system 40 for associating advertisements includes a redemption system 42. The redemption system 42 is employed to monitor the use of the voucher by the consumer. For instance, a unique identifier associated with the gift card may be stored in a first database, and the advertisements from the consumer's gift basket may be stored in a second database, in another file associated with the first database, or on the card itself with the unique identifier of the card. As the user uses the gift card to redeem gifts, offers, or rewards, the redemption system 42 may detect this change and communicate with the storage system 16 to update the storage system and/or the gift card may be updated to reflect this change. Alternatively, at a consumer's first point of use of the gift card, redeemable gifts, offers, and/or rewards could be downloaded to the card via a magnetic or smart card reader/encoder associated with the point of sale system, which could also be detected by the redemption system 42 for updating in the storage system 16. Consumers could also monitor a data log or contents of the gift card, such as on a web site or at the point-of-sale location, in order to determine what gifts, offers, and/or rewards are remaining on the gift card.

Moreover, variations of the present invention provide for tailored gift cards, baskets, and the like. For example, a gift card may be created based on a consumer's web site interaction to determine the type of goods and/or services the consumer is interested in. The locations for redemption of the advertisements provided on the gift card would typically be located in the same geographic area as the consumer. Advertisements from partners within the same geographic region could also be included, and the demographics of the consumer could also drive the type of advertisements provided on the gift card. Vendors may also wish to include advertisements in light of a particular campaign, such as the launch of a new good or service. A consumer may also independently select specific advertisements for customizing a gift card.

According to one aspect of the present invention, the system generally operates under control of a computer program product. The computer program product for performing the methods of embodiments of the present invention includes a computer-readable storage medium, such as the memory device associated with a processing element, and computer-readable program code portions, such as a series of computer instructions, embodied in the computer-readable storage medium.

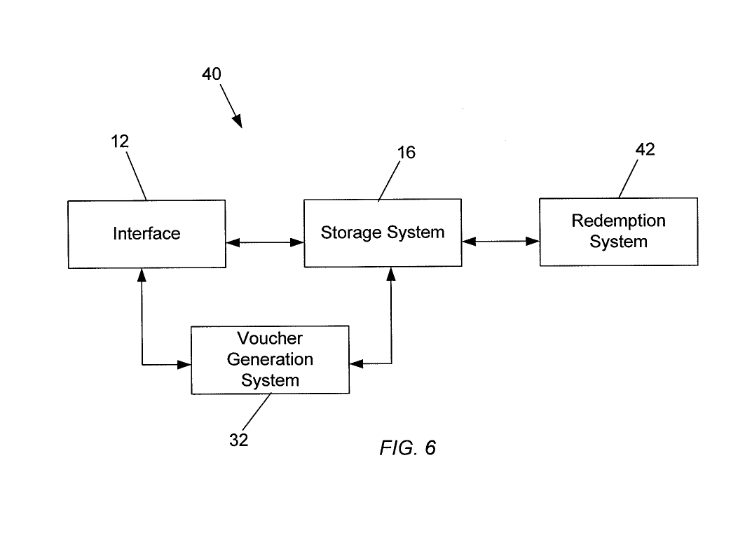

In this regard, FIGS. 2-6 are block diagrams of methods and program products according to the invention. It will be understood that functions associated with each block of the control flow diagrams, and combinations of blocks in the control flow diagrams, can be implemented by computer program instructions. These computer program instructions may be loaded onto a processing element, such as a computer, server, or other programmable apparatus, to produce a machine, such that the instructions which execute on the processing element create means for implementing the functions specified in the block(s) of the control flow diagrams or described above with respect to each block. These computer program instructions may also be stored in a computer-readable memory that can direct the processing element to function in a particular manner, such that the instructions stored in the computer-readable memory produce an article of manufacture including instruction means which implement the function specified in the block(s) of the control flow diagrams. The computer program instructions may also be loaded onto the processing element to cause a series of operational steps to be performed on the processing element to produce a computer implemented process such that the instructions which execute on the processing element provide steps for implementing the functions associated with the block(s) of the control flow diagrams.

Accordingly, blocks of the control flow diagrams support combinations of means for performing the specified functions, combinations of steps for performing the specified functions, and program instruction means for performing the specified functions. It will also be understood that each block of the control flow diagrams, and combinations of blocks in the control flow diagrams, can be implemented by special purpose hardware-based computer systems which perform the specified functions or steps, or combinations of special purpose hardware and computer instructions.

Embodiments of the present invention may provide several advantages. For example, embodiments of the present invention may provide advertisements to the user that are specifically targeted to increase the likelihood that the advertisement will be redeemed by the consumer. In addition, embodiments of the present invention may provide a user friendly and convenient system for both consumers and vendors to access and manage various gifts, offers, and/or rewards. Furthermore, aspects of the present invention may provide consumers with increased savings due to an auction system that is configured to submit bids that are based on the value of the advertisement to the user rather than the value to the vendor.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for targeting marketing to a user of a web site, said system comprising:
an interface in the form of a web site configured to provide a series of web pages viewable by a user via user selection;
a monitoring system associated with said interface, said monitoring system configured to gather information relating to navigation of the user on the interface;
a storage system comprising a list of categories associated with one or more goods and/or services; and
a point assignment system associated with said monitoring system, said point assignment system configured to assign points to the categories based on user navigation, wherein the points assigned indicate user interest in one or more goods and/or services associated with the category.

2. A system according to claim 1, wherein said storage system further comprises a plurality of advertisements, each advertisement related to one or more goods and/or services, said advertisement associated with one or more categories of the one or more goods and/or services stored in said storage system.

3. A system according to claim 2, wherein as the user navigates the web site, said point assignment system is configured to assign points to categories that relate to user selections, and wherein said interface is configured to customize the web site so as to display one or more advertisements to the user from categories having selected point values.

4. A system according to claim 1, wherein said storage system comprises categories that are hierarchal, such that the categories include one or more subcategories.

5. A system according to claim 4, wherein each subcategory defines one or more demographics.

6. A system according to claim 1, wherein said interface is configured to retrieve one or more categories from said storage system and display the categories to the user, thereby allowing the user to select categories for viewing.

7. A system according to claim 1 further comprising a search engine associated with said interface and said storage system, wherein said interface is configured to allow said user to perform one or more searches for goods and/or services.

8. A system according to claim 1, wherein at least some of the goods and/or services have an associated geographic indicator, wherein said interface is configured to display goods and/or services to the user having associated geographic indicators that correspond with that of the user.

9. A system according to claim 1, wherein said storage system is configured to store specific selections made by a user, and wherein said interface is configured to allow a user to select goods and/or services of interest and store them in the storage system along with an identification of the user.

10. A system according to claim 1 further comprising an alert system associated with said interface and said storage system, wherein said user via said interface is capable of selecting goods and/or services of interest and receiving indications when offers are available for such goods and/or services.

11. A system for providing advertisements to a consumer relating to various goods and/or services, said system comprising:
an interface in the form of a web site configured to provide a series of web pages viewable by at least one consumer via selection;
a storage system comprising a list of categories associated with one or more goods and/or services;
an entry system associated with said storage system, said storage system configured to receive and store advertisements input by a vendor for one or more goods and/or services in said storage system and associate the advertisement with one or more categories; and
an auction system associated with said interface, said auction system configured to allow vendors to place one or more bids for placement of advertisements in one or more of the categories, wherein each bid is associated with a value of the advertisement to each consumer.

12. A system according to claim 11 further comprising an advertisement monitoring system that is configured to allow each vendor to monitor statistics associated with an entered advertisement.

13. A system according to claim 11, wherein said auction system is configured to receive a bid from a vendor having a desired value equal to the value of the advertisement to each consumer and to compare a vendor's bid to other vendors' bids and select the bid having the greatest desired value.

14. A system according to claim 11, wherein said auction system is capable of receiving a bid from a vendor having an associated fair market value and to compare a vendor's bid to other vendors' bids and select the bid having the greatest fair market value.

15. A system according to claim 14 further comprising a bid valuation system for determining the fair market value of a bid entered by each vendor.

16. A system according to claim 11, wherein each advertisement comprises at least one of an offer, a gift, and a reward.

17. A system for providing advertisements to a consumer relating to various goods and/or services, said system comprising:
an interface in the form of a web site configured to provide a series of web pages viewable by at least one consumer via selection;
a monitoring system associated with said interface, said monitoring system configured to gather information relating to at the least one consumer;
a categorization system associated with said monitoring system, said categorization system configured to generate one or more categories based on the information relating to the at least one consumer;
a storage system associated with the categorization system, said storage system configured to store the generated categories based on the information relating to the at least one consumer;
an entry system associated with said storage system, said storage system configured to receive and store advertisements input by each vendor for one or more goods and/or services in said storage system and associate the advertisement with one or more of the generated categories; and
an auction system associated with said interface, said auction system configured to allow vendors to place bids for placement of advertisements in one or more of the generated categories.

18. A system according to claim 17, wherein said monitoring system is configured to allow a vendor to monitor statistics associated with an entered advertisement.

19. A system according to claim 17, wherein said auction system is configured to receive bids in the form of a traffic-based bid, wherein each vendor is capable of bidding a desired value for a predetermined number of selections by a consumer.

20. A system according to claim 17, wherein said auction system is configured to receive bids in the form of a time-based bid, wherein each vendor is capable of bidding a desired value to be an exclusive provider of one or more goods and/or services for a category.

21. A system according to claim 17, wherein said interface is configured to list more than one advertisement for one or more goods and/or services in a hierarchal list, and wherein each vendor is capable of bidding a desired value to have the vendor's advertisement appear higher in the hierarchal list.

22. A system according to claim 17, wherein said auction system is configured to receive a bid from a vendor having a desired value equal to the value of the advertisement to each consumer and to compare each vendor's bid to other vendors' bids and selects the bid having the greatest desired value.

23. A system according to claim 17, wherein said auction system is configured to receive a bid from a vendor having an associated fair market value and to compare a vendor's bid to other vendors' bids and select the bid having the greatest fair market value.

24. A system according to claim 23 further comprising a bid valuation system configured to determine the fair market value of a bid entered by a respective vendor.

25. A system according to claim 17, wherein each advertisement comprises at least one of an offer, a gift, and a reward.

26. A system according to claim 17, wherein said monitoring system is configured to gather information relating to navigation and/or demographics of the at least one consumer on said interface.

27. A system for providing one or more advertisements to a user relating to various goods and/or services, the system comprising:
an interface in the form of a web site configured to provide a series of web pages viewable by a user via selection;
a monitoring system associated with said interface, said monitoring system configured to gather information relating to navigation of the user on the interface and monitor a user's interest in one or more categories;
a storage system comprising a list of categories associated with one or more goods and/or services, wherein each category comprises one or more advertisements for goods and/or services; and
a voucher generation system associated with said interface and said storage system, wherein said voucher generation system is configured to generate a voucher comprising one or more advertisements, wherein said voucher generation system is configured to include one or more advertisements in the voucher from a category indicated by said monitoring system as an interest of the user.

28. A system according to claim 27, wherein said voucher generation system further includes one or more advertisements in the voucher selected by the user, available in the geographic location of the user, associated with a demographic of the user, and/or relating to a current sales campaign.

29. A system according to claim 27, wherein the voucher is a booklet, a card, or an email distributed to a user.

30. A system according to claim 27 further comprising a point assignment system associated with said monitoring system, said point assignment system configured to assign points to each of the categories based on user navigation, wherein the assigned points indicate a user's interest in one or more goods and/or services associated with each category.

31. A system according to claim 27, wherein each advertisement comprises at least one of an offer, a gift, and a reward.

32. A system for associating advertisements with a voucher, said system comprising:
an interface in the form of a web site configured to provide a series of web pages viewable by a user via selection;
a storage system comprising a list of categories associated with one or more goods and/or services, wherein each category comprises one or more advertisements for goods and/or services;
a voucher generation system associated with said interface and said storage system, wherein said voucher generation system is configured to generate a voucher for a user, said voucher generation system configured to create a data log in said storage system that associates a unique identification of said voucher with at least one advertisement; and
a redemption system associated with said storage system for monitoring use of the voucher by a user.

33. A system according to claim 32, wherein the voucher comprises an associated memory configured to store more than one advertisement thereon.

34. A system according to claim 33, wherein said redemption system is configured to access said storage system and download additional advertisements to the memory associated with the voucher when a user redeems a first advertisement from the voucher.

35. A system according to claim 32, wherein said redemption system is configured to access the data log stored in said storage system and indicate that the advertisement has been redeemed when the user redeems an advertisement from the voucher.

36. A system according to claim 32, wherein said interface is configured to allow a user to access the data log associated with the user.

37. A system according to claim 32, wherein the voucher is a card distributed to a user.

38. A system according to claim 32, wherein each advertisement comprises at least one of an offer, a gift, and a reward.
